(19) United States
(12) Patent Application Publication
(10) Pub. No.: US 2013/0216942 A1
(43) Pub. Date: Aug. 22, 2013

(54) POLYCARBONATE BINDER FOR ELECTROPHOTOGRAPHIC PHOTORECEPTOR COATINGS

(71) Applicants: Mohd Shamsul Hairi bin Mohd SALLEH, Tochigi (JP); James Franklin HOOVER, Evansville, IN (US); Andries J.P. VAN ZYL, Bergen op Zoom (NL); Robert Dirk VAN DE GRAMPEL, Tholen (NL); Jan-Pleun LENS, Boston, MA (US)

(72) Inventors: Mohd Shamsul Hairi bin Mohd SALLEH, Tochigi (JP); James Franklin HOOVER, Evansville, IN (US); Andries J.P. VAN ZYL, Bergen op Zoom (NL); Robert Dirk VAN DE GRAMPEL, Tholen (NL); Jan-Pleun LENS, Boston, MA (US)

(21) Appl. No.: 13/399,280

(22) Filed: Feb. 17, 2012

(51) Int. Cl. C09D 169/00; G03G 5/043; G03G 5/05

(52) U.S. Cl. 430/96; 524/876; 430/133

(57) ABSTRACT

A polycarbonate composition for an electrophotographic photoreceptor coating, wherein the polycarbonate includes 1 to 100 mole percent of first units of the formula

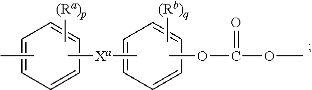

and 0 to 99 mole percent of one or more second units of the formula

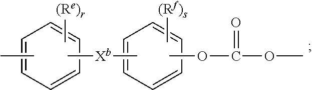

and wherein the polycarbonate has a weight average molecular weight of at least 50,000 g/mole, and a polydispersity index of 1 to 5.

### BACKGROUND

This disclosure is directed to polymer binders for use in electrophotographic photoreceptor coatings and their methods of manufacture, and in particular polycarbonate binders.

Binders for electrophotographic photoreceptor coatings require a combination of solubility in a specific solvent system, stability during the shelf life of the solution, and abrasion resistance. Polycarbonates have been used as binders in such coatings. However, depending on the solvent and other application conditions, the polycarbonate might not be soluble in the desired solvent system, or if soluble, not stable enough to retain solubility during the desired shelf life of the material. In addition, such coatings require high abrasion resistance, e.g., where rotating parts coated with the polycarbonate are in contact with abrading material. Commercially available polycarbonates based on bisphenol A (BPA) are typically not soluble in the solvent systems preferred for the manufacture of photoreceptors, or have poor stability as a solution. Furthermore, there remains a continuing perceived need in the art for compositions with improved abrasion resistance.

As stated above, polycarbonates, including some polycarbonates based on units other than BPA, have been described in the art for use in electrophotographic photoreceptors, including JP2872750, JP3765322, and JP3277964. Nonetheless, there remains a continuing need in the art for polycarbonate compositions specifically for use in electrophotographic photoreceptor coatings, in particular polycarbonate compositions having a combination of the desired solubility, stability in solution, and abrasion resistance.

### SUMMARY OF THE INVENTION

In an embodiment, provided herein is a polycarbonate composition for an electrophotographic photoreceptor coating, wherein the polycarbonate comprises 1 to 100 mole percent of first units of the formula

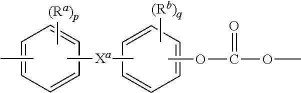

wherein R^{a} and R^{b} are each independently a halogen or a C₁₋₁₂ alkyl group, p and q are each independently integers of 0 to 4, wherein at least one of p and q is 1 to 4 and X^{a} is a C₅₋₁₈ cycloalkylidene or a C₇₋₂₅ alkylidene of formula —C(R^{c})(R^{d})— wherein R^{c} and R^{d} are each independently hydrogen, C₁₋₁₂ alkyl, C₃₋₁₂ cycloalkyl, C₇₋₁₂ arylalkyl, C₁₋₁₂ heteroalkyl, or cyclic C₇₋₁₂ heteroarylalkyl, provided that at least one of R^{c} and R^{d} is a C₆₋₁₆ cycloalkyl, and 0 to 99 mole percent of one or more second units different from the first units, of the formula

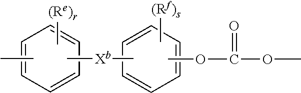

wherein R^{e} and R^{f} are each independently a halogen or a C₁₋₁₂ alkyl group, r and s are each independently 0 to 4, and X^{b} is a single bond, —O—, —S—, —S(O)—, —S(O)₂—, —C(O)—, a C₁₋₁₃ alkylidene of formula —C(R^{g})(R^{h})— wherein R^{g} and R^{h} are each independently hydrogen, C₁₋₁₂ alkyl, C₇₋₁₂ arylalkyl, C₁₋₁₂ heteroalkyl, or cyclic C₇₋₁₂ heteroarylalkyl, or a group of the formula —C(═Rⁱ)— wherein Rⁱ is a divalent C₁₋₁₂ hydrocarbon group; and wherein the polycarbonate has a weight average molecular weight of at least 50,000 g/mole, and a polydispersity index of 1 to 5.

In another embodiment, provided herein is a polycarbonate composition for an electrophotographic photoreceptor coating, wherein the polycarbonate comprises 40 to 100 mole percent of first units of formula (1b)

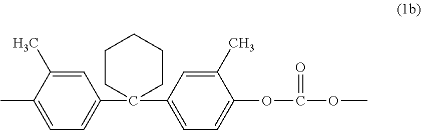

and 0 to 60 mole percent of carbonate units derived from bisphenol A (or 40 to 60 mole percent of units (1b) with the remainder bisphenol A), wherein the polycarbonate composition has a weight average molecular weight of 60,000 to 100,000 g/mole, a polydispersity index of 1.5 to 4.2, less than 2 weight percent of species having a molecular weight of less than 1000 g/mol, less than 2 parts per million by weight of chloride ion, based on parts by weight of the polycarbonate composition, less than 1 part per million by weight of a nitrogen-containing compound, based on parts by weight of the polycarbonate composition, and a film formed from the polycarbonate composition has a scratch resistance of H or harder, for example 2H or 3H, or harder, measured according to the ASTM D3363-92 Pencil Hardness Test.

Also described is a coating composition for coating an electrophotographic photoreceptor, the coating composition comprising the above-described polycarbonate compositions, and an aprotic, volatile organic solvent effective to at least partially dissolve the polycarbonate composition, wherein the concentration of the dissolved polycarbonate composition remains constant for a period of 4 weeks or more.

Still further, an electrophotographic photoreceptor comprises a charge transfer layer, the charge transfer layer comprising a charge transfer material and the above polycarbonate compositions.

A method for producing an electrophotographic photoreceptor comprises contacting a surface of a charge generation layer with a charge transfer solution comprising the above-described polycarbonate compositions, and an aprotic, volatile organic solvent effective to at least partially dissolve the polycarbonate composition and a charge transfer material; and removing the solvent.

In another embodiment, a method for reducing the polydispersity index of the polycarbonate compositions for an electrophotographic photoreceptor coating comprises contacting a solution of the above-described polycarbonate compositions in an aprotic organic solvent with an anti-solvent to precipitate the polycarbonates; and isolating the precipitated polycarbonates to provide an isolated polycarbonate composition having a molecular weight of; and separating the precipitate, thereby obtaining a polycarbonate composition for an electrophotographic photoreceptor coating having weight average molecular weight of at least 50,000 g/mole, and a polydispersity index of 1.5 to 4.2.

A method of reducing the polydispersity index of a polycarbonate composition for an electrophotographic photoreceptor coating is disclosed, the method comprising contacting a solution comprising an organic solvent selected from dichloromethane, tetrahydrofuran, or a combination comprising at least one of the foregoing, and a polycarbonate comprising 40 to 100 mole percent of first units of the formula

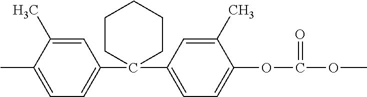

and 0 to 60 mole percent of carbonate units derived from bisphenol A, with an anti-solvent selected from a linear or aliphatic ketone, a cyclic ketone, acetic acid/acetonitrile mixture, or a combination comprising at least one of the foregoing, to precipitate the polycarbonate; and separating the precipitated polycarbonate, to provide a separated polycarbonate composition having a weight average molecular weight of 60,000 to 100,000 g/mole, a polydispersity index of 1.5 to 4.2, less than 2 weight percent of species having a molecular weight of less than 1000 g/mol, less than 2 parts per million by weight of chloride ion, based on parts by weight of the polycarbonate composition, less than 1 part per million by weight of a nitrogen-containing compound, based on parts by weight of the polycarbonate composition, and a film formed from the polycarbonate composition has a scratch resistance of H or harder, measured according to the ASTM D3363-92.

### DETAILED DESCRIPTION OF THE INVENTION

The inventors hereof have discovered an improved polymer for an electrophotographic photoreceptor coating, the polymer having both improved abrasion resistance, improved solubility, and improved storage stability. These properties render the polymer ideal for use in electrophotographic photoreceptor coatings, in particular the charge transfer layer of the electrophotographic photoreceptor. The polymer is a polycarbonate including bis(phenyl)cycloalkylidene units, where the phenyl groups are substituted with a halogen or an alkyl group. Other polycarbonate units can also be present in the polymer, including, but not limited to bisphenol A or other aromatic dihydroxy compounds; wherein said selection is dependent on photoreceptor requirements. The inventors have further obtained the polycarbonates with improved polydispersity and low ionic species content, which is also advantageous in improving hardness and abrasion resistance, as well as the imaging process during use of the electrophotographic photoreceptor coatings.

The polycarbonate for an electrophotographic photoreceptor coating comprises 1 to 100 mole percent of repeating bis(phenyl)alkylidene units of formula (1).

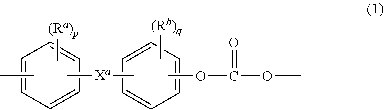

In formula (1), R^{a} and R^{b} are each independently a halogen or a C₁₋₁₂ alkyl group, specifically a C₁₋₆ alkyl group, more specifically a C₁₋₃ alkyl group, still more specifically methyl.

Further in formula (1), p and q are each independently integers of 0 to 4, wherein at least one of p and q is 1 to 4. Specifically, p and q are each integers of 1 to 4, 1 to 3, 1 to 2, or 1. In the foregoing embodiments, the substituents R^{a} and R^{b} can be disposed anywhere on the phenyl rings. In an embodiment, at least one substituent, or at least one substituent on each phenyl ring is disposed meta to X^{a}.

Also in formula (1), X^{a} is a C₅₋₁₈ cycloalkylidene or a C₇₋₂₅ alkylidene of the formula —C(R^{c})(R^{d})— wherein R^{c} and R^{d} are each independently hydrogen, C₁₋₁₂ alkyl, C₃₋₁₂ cycloalkyl, C₇₋₁₂ arylalkyl, C₁₋₁₂ heteroalkyl, or cyclic C₇₋₁₂ heteroarylalkyl, provided that at least one of R^{c} and R^{d} is a C₆₋₁₆ cycloalkyl. In a specific embodiment, X^{a} is a C₆₋₁₂ cycloalkylidene, specifically a cycloalkylidene having 6 carbon atoms in the ring, and zero, one, two, three, or four substituents having a total of 0 to 6 carbon atoms.

For example in formula (1), R^{a} and R^{b} are each a C₁₋₃ alkyl group, specifically a methyl group, p and q are each 1-2, specifically 1, and X^{a} is a C₅₋₁₂ cycloalkylidene wherein the cycloalkyl ring has 5 to 7 carbon atoms, with the remaining carbon atoms being substituents on the ring. Combinations of different units of formula (1) can be present.

Units of formula (1) can be derived from the corresponding bisphenol compounds. A nonexclusive list of such compounds includes 1,1-bis(4-hydroxyphenyl)cyclopentane, 1,1-bis(4-hydroxyphenyl)cyclohexane, 1,1-bis(4-hydroxyphenyl)cyclododecane, and 1,1-bis(4-hydroxyphenyl)-1-cyclohexyl-ethane.

In some embodiments, the repeating bis(hydroxyphenyl)alkylidene units are bis(hydroxyphenyl)cyclohexylalkylidene units of formula (1a)

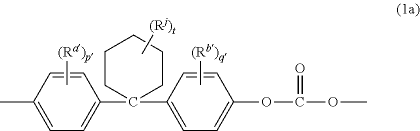

wherein R^{a′} and R^{b′} are each independently halogen or C₁₋₁₂ alkyl, R^{j} is C₁₋₁₂ alkyl or halogen, p′ and q′ are each independently 1 to 4, and t is 0 to 10. In another embodiment of formula (1a), R^{a′} and R^{b′} are each independently C₁₋₄ alkyl, R^{j} is C₁₋₄ alkyl, p′ and q′ are each 1 to 2, and t is 0 to 5.
In still another embodiment, the repeating bis(hydroxyphenyl)cycloalkylidene units are units of formula (1b).

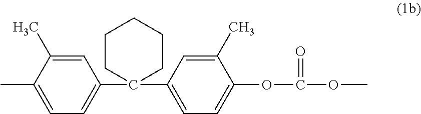

Units (1b) are derived from 1,1-bis(4-hydroxy-3-methylphenyl)cyclohexane, also known as dimethyl bisphenol cyclohexane (DMBPC). Polycarbonates containing units derived from DMBPC can be abbreviated DMBPC-PC.

The polycarbonates can further optionally comprise one or more second units different from the first, bis(hydroxyphenyl)alkylidene units of formula (1), formula (1a), or formula (1b). In particular, the polycarbonate comprises 0 to 99 mole percent of one or more second units of formula (2).

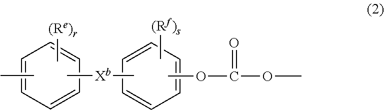

In formula (2), R^{e} and R^{f} are each independently a halogen or a C₁₋₁₂ alkyl group. Specifically R^{e} and R^{f} are each a C₁₋₃ alkyl, more specifically methyl.

Further in formula (2), r and s are each independently 0 to 4, specifically 0 to 2, more specifically 0 or 1.

Also in formula (2), X^{b} is a single bond, —O—, —S—, —S(O)—, —S(O)₂—, —C(O)—, or a C₁₋₂₅ alkylidene of the formula —C(R^{g})(R^{h})— wherein R^{g} and R^{h} are each independently hydrogen, C₁₋₁₂ alkyl, C₇₋₁₂ arylalkyl, C₁₋₁₂ heteroalkyl, or cyclic C₇₋₁₂ heteroarylalkyl, or a group of the formula —C(═Rⁱ)— wherein Rⁱ is a divalent C₁₋₁₂ hydrocarbon group. Specifically, X^{b} is a single bond, —O—, —S—, —S(O)—, —S(O)₂—, —C(O)—, or a C₁₋₂₅ alkylidene of the formula —C(R^{g})(R^{h})— wherein R^{g} and R^{h} are each independently hydrogen or C₁₋₆ alkyl. More specifically in formula (2), X^{b} is a single bond, —O—, —S—, —S(O)—, —S(O)₂—, —C(O)—, or isopropylidene.

In a specific embodiment of formula (2), r and s are each 0, and X^{b} is a single bond, —O—, —S—, —S(O)—, —S(O)₂—, —C(O)—, or a C₁₋₂₅ alkylidene of the formula —C(R^{g})(R^{h})— wherein R^{g} and R^{h} are each independently hydrogen or C₁₋₆ alkyl, more specifically a single bond, —O—, —S—, —S(O)—, —S(O)₂—, —C(O)—, or isopropylidene.

Units of formula (2) can be derived from the corresponding bisphenol compounds. A nonexclusive list of such compounds includes 1,1-bis(4-hydroxyphenyl)methane, 1,1-bis(4-hydroxyphenyl)ethane, 2,2-bis(4-hydroxyphenyl)propane (also known as “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, and 1,1-bis(4-hydroxy-t-butylphenyl)propane. Units derived from bisphenol A can be specifically mentioned.

Polycarbonates comprising units (1), specifically (1a), more specifically (1b), and optionally units (2) can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of DMBPC or BPA). Among the exemplary phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX wherein X is Cr, Br, a C₁₋₈ alkoxy group or C₆₋₁₈ aryloxy group. An effective amount of a phase transfer catalyst can be about 0.1 to about 10 wt. % based on the weight of bisphenol in the phosgenation mixture. In another embodiment, an effective amount of phase transfer catalyst can be about 0.5 to about 2 wt. % based on the weight of bisphenol in the phosgenation mixture.

Alternatively, melt processes can be used. Generally, in the melt polymerization process, the polycarbonates can be prepared by co-reacting, in a molten state, the dihydroxy reactant(s) and a diaryl carbonate ester, such as diphenyl carbonate, in the presence of a transesterification catalyst. Volatile monohydric phenol is removed from the molten reactants by distillation and the polymer is isolated as a molten residue.

Branched polycarbonate polymers and copolymers can also be useful, as well as blends comprising a linear polycarbonate and a branched polycarbonate. The branched polycarbonates can be prepared by adding a branching agent during polymerization, for example a polyfunctional organic compound containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of about 0.05 to 2.0 wt. %. All types of polycarbonate end groups are contemplated as being useful in the polycarbonate composition, provided that such end groups do not significantly affect desired properties of the thermoplastic compositions. In an embodiment, the polycarbonate is a linear.

After manufacture, the polycarbonates can be isolated by means known in the art and further processed, if needed, to obtain the desired properties, in particular solubility, solution stability, and abrasion resistance. In an embodiment, the polycarbonates are precipitated using a solvent and an anti-solvent. As discussed further below, the polycarbonates are soluble in certain aprotic, lower boiling point organic solvents such as tetrahydrofuran, and methylene chloride. An “anti-solvent” as used herein means a solvent which, when added in a sufficient quantity, causes a polymer to precipitate from a solution without removal or reduction of the solvent medium. This is to be distinguished from non-solvents, which do not affect the solubility of a polymer within a solution when introduced in any quantity. The polymer is insoluble in both non-solvents and anti-solvents, but to precipitate a polymer by addition of a non-solvent, the solvent for the polymer must first be removed. Effective anti-solvents for the polycarbonates can have a higher vaporization temperature (i.e., boiling point (b.p.)) than the solvent that dissolves and contains the polymer, which permits vaporization of the solvent without significant vaporization of the organic anti-solvent, for example without vaporization of more than 50% of the total anti-solvent. For example, the difference in boiling point between the anti-solvent and the solvent can be 10 to 100° C., 15 to 80° C., or 20 to 60° C. Precipitation with an anti-solvent is particularly useful to obtain polycarbonates having a low polydispersity index and low levels of contaminants, particularly compounds having a molecular weight of less than 1000 g/mole.

When the solvent is dichloromethane or THF, examples of anti-solvents that can be used for precipitation include, acetonitrile (b.p. 82° C.), linear or branched aliphatic ketones, cycloaliphatic ketones, and mixtures of acetic acid and acetonitrile. The volume ratio of the mixtures of acetic acid:acetonitrile can be in the ranges of 1:99 to 99:1, or 10:90 to 90:10. Aliphatic ketones that can be used include acetone (b.p. of 56-57° C.) and methylethylketone (b.p. of 80° C.). Methylpropylketone, methylisobutylketone, methyl-sec-butylketone, diisobutylketone, or diethylketone, all of the foregoing with a boiling point (b.p.) of 100 to 102° C. can be used; pinacolone (b.p. of 106° C.), methyl-n-butylketone (b.p. of 127° C.), methylisoamylketone (b.p. of 145° C.), diisopropylketone (b.p. of 125° C.), ethylpropylketone (b.p. of 123° C.) and butylethylketone (b.p. of 147° C.). Likewise, cyclic aliphatic ketones include cyclobutanone (b.p. of 100 to 102° C.), cyclopentanone (b.p. of 130° C.), cyclohexanone (b.p. of 157° C.), heptanone (b.p. of 179 to 181° C.), and methylcyclohexanone (b.p. of 165 to 166° C.), wherein each boiling point is at 103.3 kPa (760 mm Hg). These compounds can be used either individually or in combination. When dichloromethane (b.p. of 40° C.) is used as the solvent and acetone (b.p. of 56° C.) is used as an anti-solvent, removal of the solvent can be effected at a temperature of 45-50° C., which is higher than the boiling point of the dichloromethane and lower than the boiling point of the acetone.

Thus, in an embodiment, a method of reducing the polydispersity index of a polycarbonate composition for an electrophotographic photoreceptor coating comprises contacting a solution comprising the above-described polycarbonate with an amount of antisolvent effective to precipitate the polycarbonate. The precipitated polycarbonate is then isolated, for example by filtering. The precipitated polycarbonate composition can have an Mw of at least 50,000 g/mol, and a polydispersity index of 1.5 to 4.2, or 1.5 to 3.5, or 1.5 to less than 2.0. In an embodiment the solvent is selected from dichloromethane, THF, or a combination comprising at least one of the foregoing; and the anti-solvent is a linear or branched aliphatic ketone, cycloaliphatic ketone, or mixture of acetic acid and acetonitrile, or a combination comprising at least one of the foregoing, and in particular acetone. Excellent results are obtained when DMBPC-PC homopolymers and DMBPC-PC/BPA-PC copolymers are precipitated using dichloromethane as a solvent and acetone as an anti-solvent. DMBPC-PC/BPA-PC copolymers in particular having an Mw of 50,000 to 85,000 g/mol, or 60,000 to 85,000 g/mol can be produced having a PDI of 1.5 to 4.2, or 1.5 to 3.5, or 1.5 to less than 2.0.

In the polycarbonates, the relative molar ratios of units (1)), specifically (1a), more specifically (1b), and optional units (2) are adjusted to achieve the desired degree of solubility, solution stability, and abrasion resistance. For example, the polycarbonates comprise 1 to 100 mole percent (mol %) of units (1) and 0 to 99 mol % of units (2), or 5 to 95 mol %, 20 to 80 mol %, 30 to 70 mol %, or 40 to 60 mol % of units (1), with the remaining units being one or more units (2). In a specific embodiment, the polycarbonates comprise 1 to 100 mol % of units derived from DMBPC and 0 to 99 mol % of units derived from BPA, or 5 to 95 mol %, 20 to 80 mol %, 30 to 70 mol %, or 40 to 60 mol % of units derived from DMBPC, with the remaining units being derived from BPA.

Polycarbonates comprising units (1) and optionally units (2) have a weight average molecular weight (M_{W}) of at least 50,000 g/mol, specifically 50,000 to 150,000 g/mol, or 50,000 to 100,000 g/mol, or 50,000 to 85,000 g/mol. In another embodiment, polycarbonates comprising units (1) and optionally units (2) have an M_{W} of 60,000 to 150,000 g/mol, or 60,000 to 100,000 g/mol, or 60,000 to 85,000 g/mole. Even more specifically polycarbonates comprising units (1) and optionally units (2) have an M_{W} of 70,000 to 150,000 g/mol, or 70,000 to 100,000 g/mol, or 70,000 to 85,000 g/mol. For example, polycarbonates comprising units derived from DMBPC and optionally BPA have a weight average molecular weight (M_{W}) of greater than 50,000 g/mol, 50,000 to 150,000 g/mol, or 50,000 to 100,000 g/mol, or 50,000 to 85,000 g/mol. In another embodiment, polycarbonates derived from DMBPC and optionally BPA have an M_{w} of 60,000 to 150,000 g/mol, or 60,000 to 100,000 g/mol, or 60,000 to 85,000 g/mol. Even more specifically polycarbonates comprising units derived from DMBPC and optionally BPA have an M_{W} of 70,000 to 100,000 g/mol, or 70,000 to 85,000 g/mol. M_{W} can be determined by gel permeation chromatography (GPC) using an automated injection system, two linear ultra-styragel mixed bed columns (operating at 30° C.) and a UV detector set at 254 nm. The samples are dissolved in dichloromethane with 0.1% toluene (reference) and eluted at 1.5 ml/min. Results are reported based on polycarbonate standards.

The polycarbonates further have a polydispersity index (PDI) from 1 to 5, 1 to 4, 1 to 3.5, or 1.5 to 4.2, or 1.5 to 3.5, or 1.5 to less than 2.0. As further shown in Table 2 in the Examples, the PDI of DMBPC homopolymer and DMBPC-BPA-PC copolymers increases with an increase in weight average molecular weight. Likewise, the PDI of DMBPC-PC polycarbonate copolymer increases with an increase in the mol % of DMBPC with the largest PDI observed in high molecular weight DMBPC homopolymer. It is particularly difficult to obtain DMBPC homopolymers and copolymers having an Mw of 50,000 g/mol or higher with a PDI of less than 4.2 or less than 3.5 or less than 2.0 unless, for example, special monomer purification methods are used. Similarly, it is particularly difficult to obtain DMBPC homopolymers and copolymers having an Mw of 70,000 g/mol or higher with a PDI of less than 5. The PDI of the copolymers increases even further with higher molar ratios of DMBPC, e.g., 50 mole % or higher.

In certain embodiments, the polycarbonate compositions have low levels of low molecular weight species, in particular species having a molecular weight of less than 1000 g/mole. Without being bound by theory, decreasing the levels of these low molecular weight species also improves the solubility and solution stability of the polycarbonates. Accordingly, the polycarbonate compositions contain less than 2 wt. %, less than 1.5 wt. %, or less than 1 wt. % of such low molecular weight species, based on the total weight of the polycarbonate compositions. Some polycarbonate compositions may contain higher than desirable levels of low Mw species that can be reduced or nearly removed by anti-solvent precipitation of the polymer. Thus, obtaining compositions having the desired percentage of low molecular weight species is possible by the precipitation procedure using an anti-solvent as described herein. By selecting the proper solvent/anti-solvent combination, the desired percentage of low molecular species can be obtained. In an especially advantageous feature, both the desired percentage of low molecular species and the desired PDI can be obtained, for example less than 2 wt. %, less than 1.5 wt. %, or less than 1 wt. % of such low molecular weight species in combination with a PDI of 1.5 to 4.2, or 1.5 to 3.5, or 1.5 to less than 2.0.

The charge transfer characteristics of the coating made from the polycarbonates are improved when the level of ionic species is low. Accordingly, the polycarbonate compositions comprise less than 2 parts per million (ppm) by weight of a chloride ion(s), based on parts by weight of the polycarbonate composition; and less than 1 ppm by weight of a nitrogen-containing compound(s), based on parts by weight of the polycarbonate composition. Analyzing for the presence and concentration of chloride ion(s) can be accomplished, for example, using ion chromatography, or via silver-nitrate titration. Likewise, analyzing for the presence and concentration of nitrogen-containing compound(s), can be performed, for example, using ultraviolet/visual (UV-Vis) spectroscopy, measuring absorbance at 254 nm relative to a standard.

The polycarbonates can further have a solubility in tetrahydrofuran (THF) of at least 5% weight/volume, at least 10% weight/volume, at least 20% weight/volume, or at least 30% weight/volume, up to about 65% weight/volume. In an embodiment, the polycarbonates have a solubility of 5% to 60% weight/volume in THF.

In a highly advantageous feature, solutions containing the polycarbonates are stable over time, that is, the concentration of the dissolved polycarbonate in a solution containing 10% polycarbonate/THF (weight/volume) or 20% polycarbonate/THF (weight/volume) remains constant after 4 weeks at room temperature. In some embodiments, the concentration of the dissolved polycarbonate solution containing 10% polycarbonate/THF (weight/volume) or 20% polycarbonate/THF (weight/volume) remains constant after 5 weeks, 6 weeks, 12 weeks, 16 weeks, or 20 weeks at room temperature. Alternatively, or in addition to the concentration of the dissolved polycarbonate composition remaining constant as described above, no haze, precipitate, or sediment is observed after the stated periods of time at the stated concentrations.

When used to form a coating, the polycarbonate compositions as described in this application have a scratch resistance of HB or harder, measured according to the ASTM D3363-92a Pencil Hardness Test. The compositions can have a scratch resistance of F or harder, H or harder, 2 H or harder, 3 H or harder. Pencil hardness is often related to abrasive resistance. Thus, abrasive resistance can be improved in these polycarbonate compositions in comparison to BPZ-PC, and even further improved with an increase in the mol % of DMBPC units in the copolymers of the polycarbonate compositions.

The above properties of the polycarbonate compositions can be adjusted by modifying the molar ratios of units (1) and (2), the molecular weight of the polycarbonates, and processing conditions, in particular precipitation using an antisolvent. For example, in an embodiment, the polycarbonate composition for an electrophotographic photoreceptor coating includes 40 to 100 mol % of first units of formula (1b)

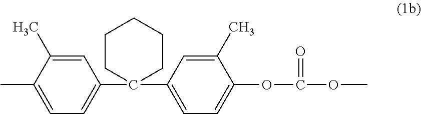

and 0 to 60 mol % of carbonate units derived from bisphenol A (or 40 to 60 mole percent of units (1b) with the remainder units being bisphenol A), wherein the polycarbonate composition has a weight average molecular weight of 50,000 to 150,000 g/mole, a polydispersity index of 1.5 to less than 4.2, less than 2 weight percent of species having a molecular weight of less than 1000 g/mol, less than 2 parts per million by weight of a chloride ion, based on parts by weight of the polycarbonate composition, less than 1 part per million by weight of a nitrogen-containing compound, based on parts by weight of the polycarbonate composition. A film formed from this polycarbonate composition has a scratch resistance of H or harder, measured according to the ASTM D3363-92a Pencil Hardness Test. The film can be formed as described below, for example by dipping an electrophotographic photoreceptor drum in the solution of the composition described herein and slowly evaporating the solvent. In some embodiments, these polycarbonate compositions are obtained by precipitation of the polycarbonates from a solution in dichloromethane with an anti-solvent, for example an aliphatic or cycloaliphatic ketone such as acetone, or mixture of acetic acid and acetonitrile.

In another embodiment, the polycarbonate composition for an electrophotographic photoreceptor coating includes 40 to 100 mol % of first units of formula 1(b)

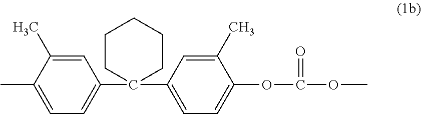

and 0 to 60 mol % of carbonate units derived from bisphenol A (or 40 to 60 mole percent of units (1b) with the remainder bisphenol A), wherein the polycarbonate composition has a weight average molecular weight of 60,000 to 85,000 g/mole, a polydispersity index of 1.5 to 3.5 or 1.5 to less than 2.0, less than 1 weight percent of species having a molecular weight of less than 1000 g/mol, less than 2 parts per million by weight of chloride ion, based on parts by weight of the polycarbonate composition, less than 1 part per million by weight of a nitrogen-containing compound, based on parts by weight of the polycarbonate composition, and a film formed from the polycarbonate composition has a scratch resistance of H or harder, measured according to the ASTM D3363-92a Pencil Hardness Test. The film can be formed as described below, for example by dipping an electrophotographic photoreceptor drum in the solution of the composition described herein and evaporating the solvent. Specifically, the solvent can be removed slowly. In some embodiments, these polycarbonate compositions are obtained by precipitation of the polycarbonates from a solution in dichloromethane with an anti-solvent such as acetone.

The polycarbonates are used as binders in the charge transfer layers or of electrophotographic photoreceptors. As is known in the art, electrophotographic photoreceptors comprise an electrically conductive substrate and a photoconductive layer disposed on the conductive substrate. The electrically conductive substrate can be a metal such as aluminum, copper, tin, platinum, gold, silver, vanadium, molybdenum, chromium, cadmium, titanium, nickel, indium, stainless steel or brass; a non-electrically conductive material such a plastic on which a metal is deposited or laminated; or glass coated with aluminum iodide, tin oxide, indium oxide; and the like. The electrically conductive substrate can be in the form of a drum or a belt. The photoconductive layer can be in the form of a laminate, comprising a charge-generating layer disposed on the electrically conductive substrate and a charge-transferring layer disposed on the charge-generating layer; or the photoconductive layer can be in the form of a single layer comprising a charge generating material and a charge transfer material dispersed in a single layer. Such single layers are also referred to herein as charge transfer layers.

Accordingly, an electrophotographic photoreceptor comprises a charge transfer layer, wherein the charge transfer layer comprises a charge transfer material and the polycarbonate composition as described above. Charge transfer materials are known, and can generally be classified into two groups, i.e., those transporting electrons and those transporting positive holes, and either of the two groups can be used in the charge transfer layers. As the compounds which transport electrons, examples include 2,4,7-trinitro-9-fluorenone, 2,4,5,7-tetranitro-9-fluorenone, 9-dicyanomethylene-2,4,7-trinitrofluorenone, 9-dicyanomethylene-2,4,5,7-tetranitrofluorenone, tetranitrocarbazole, chloranil, 2,4,7-trinitro-9,10-phenanthrenequinone, tetrachlorophthalic anhydride, tetracyanoethylene and tetracyanoquinodimethane. As the compounds which transport positive holes, there can be mentioned compounds such as polyvinylcarbazole and derivatives thereof, polyvinylpyrene, polyvinylanthracene, poly-2-vinyl-4-(4′-dimethylaminophenyl)-5-phenyloxazole and poly-3 vinyl-N-ethylcarbazole, polyacenaphthylene, polyindene, pyrene-formaldehyde resins, bromopyrene formaldehyde resins, the triazole derivatives, oxadiazole derivatives, imidazole derivatives, pyrazoline derivatives and pyrazolone derivatives, amino-substituted chalcone derivatives, and others. The weight ratio of the charge transfer material to the polycarbonate can be from 1:10 and 10:1.

In some embodiments, the charge transfer layer further comprises a charge generating material. In these embodiments the charge transfer layer is a single layer disposed directly on the electrically conductive substrate of the electrophotographic photoreceptor. Charge generating materials are known, and include, for example, organic compounds such as phthalocyanine pigments, azo pigments, quinone pigments, perylene pigments, indigo pigments, bisbenzoimidazole pigments, quinaclydone pigments, pyrilium pigments, triarylmethane pigments, cyanine pigments, and the like. A combination comprising different pigments can be used. The weight ratio of the charge generating material and the charge transfer material to the polycarbonate can be from 2:10 and 10:2.

The charge transfer layer can further include various additives ordinarily incorporated into charge transfer layers, with the proviso that the additive(s) are selected so as to not significantly adversely affect the desired properties of the charge transfer layer, in particular solubility, solution stability, and abrasion resistance. Such additives can be mixed at a suitable time during the mixing of the components for forming the coating composition as further described below. Exemplary additives include antioxidants, heat stabilizers, light stabilizers, ultraviolet (UV) light stabilizers, and lubricants. A combination of additives can be used. For example a combination of an antioxidant and ultraviolet light stabilizer. In general, the additives are used in the amounts generally known to be effective, for example 0.01 to 1 wt. %, based on the total weight of the charge transfer layer.

The thickness of the charge transfer layer depends on the desired properties. For example, when a single layer, the charge transfer layer can have a thickness of 10 to 60 micrometers, or 20 to 40 micrometers. When in the form of a laminate, the charge transfer layer can have a thickness of 2 to 100 micrometers, or 5 to 40 micrometers.

The charge transfer layers are generally produced by coating methods. A coating composition for coating an electrophotographic photoreceptor includes the polycarbonate compositions as described herein, and an aprotic, volatile organic solvent effective to at least partially dissolve the polycarbonate composition. Such solvents include THF, 1,4-dioxane, a halogenated solvent such as chloroform, 1,1,1-trichloroethane, monochloroethane, carbon tetrachloride, dichloromethane, and the like. A combination of aprotic, volatile organic solvents can be used.

As described above, the concentration of the dissolved polycarbonate composition remains constant for a period of 4 weeks or more. The relative amount of polycarbonate and solvent can be adjusted depending on the coating methods and desired thickness of the coating, and can be, for example, 5 to 50% polycarbonate/solvent (weight/volume), or 5 to 30% polycarbonate/solvent (weight/volume). In use, the coating composition can further comprise one or more additives as described above and one or more charge transfer agents in amounts effective to provide the desired concentration in the charge transfer layers. The components of the compositions used to form the charge transfer layer can be combined with the solvent in any order.

A method for producing an electrophotographic photoreceptor includes contacting a surface of a charge generation layer with a charge transfer solution comprising the coating composition and further including a charge transfer material; and removing the solvent to form the layer. In another embodiment, where the photoconductive layer is in the form of a single layer, a method for producing an electrophotographic photoreceptor includes contacting a surface of an electrically conductive substrate with a charge transfer solution comprising the coating composition and further including a charge transfer material and the charge generating material; and removing the solvent to form the layer. Contacting can be by methods such as casting, spray coating dip coating and the like. Removal of the solvent can be by methods known in the art, for example drying, forced heat drying, under vacuum, and the like.

The invention is further illustrated by the following non-limiting Examples.

### EXAMPLES

The materials used in the Examples are described in Table 1.

TABLE 1

| Material | Chemical description | Source |
|---|---|---|
| BPA-PC | Bisphenol-A polycarbonate | SABIC |
| | homopolymer, M_{W} about | INNOVATIVE |
| | 25,000 to 75,000 g/mol, | PLASTICS |
| | determined via GPC using | |
| | polycarbonate standards | |
| BPZ-PC | 1,1-bis(4-hydroxyphenyl) | SABIC |
| | cyclohexane polycarbonate | INNOVATIVE |
| | homopolymer [CAS. 843-55-0] | PLASTICS |
| DMBPC | Dimethyl bisphenol cyclohexane | Various (e.g. |
| | [CAS. 2362-14-3] | TCI America) |
| DMBPC-PC 25 | Dimethyl bisphenol cyclohexane- | SABIC |
| | bisphenol A polycarbonate copolymer | INNOVATIVE |
| | containing 25 mol % of dimethyl | PLASTICS |
| | bisphenol cyclohexane units, M_{W} | |
| | about 25,000 to 75,000 g/mol, | |
| | determined via GPC using | |
| | polycarbonate standards | |
| DMBPC-PC 50 | Dimethyl bisphenol cyclohexane- | SABIC |
| | bisphenol A polycarbonate copolymer | INNOVATIVE |
| | containing 50 mol % of dimethyl | PLASTICS |
| | bisphenol cyclohexane units, M_{W} | |
| | about 25,000 to 85,000 g/mol, | |
| | determined via GPC using | |
| | polycarbonate standards | |
| DMBPC-PC 75 | Dimethyl bisphenol cyclohexane- | SABIC |
| | bisphenol A polycarbonate copolymer | INNOVATIVE |
| | containing 75 mol % of dimethyl | PLASTICS |
| | bisphenol cyclohexane units, M_{W} | |
| | about 25,000 to 75,000 g/mol | |
| | determined via GPC using | |
| | polycarbonate standards | |
| DMBPC-PC | Dimethyl bisphenol cyclohexane | SABIC |
| | polycarbonate homopolymer, M_{W} | INNOVATIVE |
| | about 25,000 to 85,000 g/mol, | PLASTICS |
| | determined via GPC using | |
| | polycarbonate standards | |
| THF | Tetrahydrofuran [CAS. 109-99-9] | Various |

### Examples 1-12 and Comparative Examples 1-6

Tests were performed to evaluate the solubility and retention of various polycarbonates and polycarbonate blends in an organic volatile solvent (THF). Formulations and results are summarized in Table 2.

TABLE 2

| | | | | | Solubility in THF | | |
|---|---|---|---|---|---|---|---|
| | | Mw | DMBPC | | (wt polymer/volume THF) | | |
| Type | Composition | (g/mol) | (mol %) | Ex. No. | 10% | 20% | PDI |
| Homopolymer | BPA-PC | 22,000 | 0 | CEX1 | Insoluble | Insoluble | — |
| | | 30,000 | | CEX2 | | Insoluble | — |
| Blend | DMBPC-PC50/BPA- | 23,300 | 25 mol % | CEX3 | Insoluble | — | 2.7 |
| | PC | 22,000 | | | | | — |
| | 1/1 ratio | | | | | | |
| | DMBPC-PC/BPA- | 24,580 | 50 mol % | CEX4 | Insoluble | — | 3.3 |
| | PC | 22,000 | | | | | |
| | 1/1 ratio | | | | | | |
| | BPZ-PC/BPA- | 30,000 | 0 | CEX5 | Insoluble | — | — |
| | PC | 22,000 | | | | | |
| | 1/1 ratio | | | | | | |
| Copolymer | DMBPC-PC 25 | 25,000 | 25 mol % | EX1 | <11 weeks | <5 weeks | 2.7 |
| | | 75,000 | | EX2 | <15 weeks | <10 weeks | 5.2 |
| Copolymer | DMBPC-PC 50 | 23,300 | 50 mol % | EX3 | 5 months | <12 weeks | 2.7 |
| | | 60,000 | | EX4 | 5 months | <16 weeks | 3.5 |
| | | 70,000 | | EX5 | 5 months | 5 months | 5.8 |
| | | 85,000 | | EX6 | 5 months | 5 months | 7.2 |
| Copolymer | DMBPC-PC 75 | 25,000 | 75 mol % | EX7 | 5 months | <15 weeks | 3.9 |
| | | 75,000 | | EX8 | 5 months | 5 months | 6.9 |
| Homopolymer | DMBPC-PC | 24,580 | 100 mol % | EX9 | 5 months | 5 months | 3.3 |
| | | 67,000 | | EX10 | 5 months | 5 months | 8.3 |
| | | 70,000 | | EX11 | 5 months | 5 months | 8.2 |
| | | 85,000 | | EX12 | 5 months | 5 months | 8.4 |

Samples were stored at room temperature and were visually inspected on a weekly basis up to 5 months. A hazy solution indicated solution instability, i.e., that the material became at least partially insoluble in the solution. Such haze can be observed by visual inspection without magnification under ambient light conditions. Results are reported as the number of weeks where the hazy solution was observed. For example, a value of “<11 weeks” indicates a solution where the material remained in solution for more than 10 weeks and less than 11 weeks. Comparative examples CEX1-CEX5 demonstrate that homopolymers of bisphenol A (BPA-PC) and its blends are not soluble in a volatile organic solvent (THF) over the tested range of concentrations (10-20% (w/v)). By introducing DMBPC in the polycarbonate backbone in an amount from 25 to 100 mol % (EX1-EX12) the solubility is improved. As demonstrated in Table 2, the ability of the material to remain in solution decreases with increasing concentration (w/v) of the material in the solvent at a given molecular weight.

Overall, the solution stability (defined by the number of weeks up to 5 months in which the material remains in solution) at higher concentrations (i.e., at 20% w/v) improves with increasing molecular weight of the polycarbonate copolymers (compare EX3 with EX5-EX6). Surprisingly, by incorporating a DMBPC monomer into a polycarbonate, both the solubility of the copolymer and its solution stability (ability to remain in solution without cloudiness or precipitation) improves. Even more surprisingly, the solution stability of the polymer over time is improved as the molecular weight of the copolymer increases (see EX3 to EX6 and EX10 to EX12).

A comparison was made to investigate the abrasion resistance and hardness of the polycarbonate copolymers against BPA-PC and an industry standard, BPZ-PC. Results are shown in Table 3.

TABLE 3

| | | Pencil Hardness |
|---|---|---|
| Ex. No. | Material | (ASTM D3363-92.a) |
| CEX1 | BPA-PC | 2B |
| CEX5 | BPZ-PC | HB |
| EX6 | DMBPC-PC 50 | H |
| EX9 | DMBPC-PC | 3H |

These results show that pencil hardness increases and improves in comparison to BPZ-PC with an increase in the mol % of DMBPC units in the copolymer.

### Examples 13-20

The polydispersity index (PDI) of various polycarbonates and polycarbonate blends was adjusted using a re-precipitation process from methylene chloride with an anti-solvent at room temperature. Results are shown in Table 4.

TABLE 4

| Ex. | | | Mw | Mn | | |
|---|---|---|---|---|---|---|
| No. | Composition | Anti-Solvent | (g/mol) | (g/mol) | PDI | % lows <1000 g/mol |
| CEX13 | 50 mol % | [None- | 75,700 | 12,200 | 6.21 | 2.4 |
| | DMBPC | precipitation] | | | | |
| CEX14 | 50 mol % | Methanol | 74,800 | 13,900 | 5.35 | 1.9 |
| | DMBPC | | | | | |
| EX15 | 50 mol % | Acetonitrile | 77,800 | 25,900 | 3.01 | 0.48 |
| | DMBPC | | | | | |
| EX16 | 50 mol % | Acetone | 79,200 | 42,300 | 1.87 | 0 |
| | DMBPC | | | | | |
| EX17 | 50 mol % | Ethyl acetate* | — | — | — | — |
| | DMBPC | | | | | |
| CEX18 | 50 mol % | DMF/H₂O | 76,600 | 12,900 | 5.95 | 2.22 |
| | DMBPC | | | | | |
| EX19 | 50 mol % | 50/50 | 77,800 | 21,700 | 3.59 | 0.78 |
| | DMBPC | Acetic acid/MeCN | | | | |
| EX20 | 50 mol % | 25/75 | 77,800 | 19,900 | 3.91 | 0.99 |
| | DMBPC | Acetic acid/MeCN | | | | |

*Copolymer remained semi-dissolved

Table 4 demonstrates that the PDI of the copolymers could be significantly improved, from a value of 6.21 (CEX13) to less than 2 (EX16). The percentage of low molecular weight species as determined by GPC (the area under the curve against retention time) (less than 1000 g/mol) are also shown to significantly decrease to no more than 2.22% and even to 0% in some cases (EX16). Acetone proved to be the best anti-solvent (EX16), as it provided the lowest PDI (a PDI of less than 2 (1.87) and zero percent of low molecular weight species. A PDI of lower than 2.5 allows better abrasive resistance to be achieved.

The singular forms “a,” “an,” and “the” include plural referents unless the context clearly dictates otherwise. “Or” means “and/or.” In general, the embodiments can comprise, consist of, or consist essentially of, any appropriate components herein disclosed. The embodiments can additionally, or alternatively, be formulated so as to be devoid, or substantially free, of any components, materials, ingredients, adjuvants or species used in the prior art compositions or that are otherwise not necessary to the achievement of the function and/or objectives as described herein. The endpoints of all ranges directed to the same component or property are inclusive and independently combinable (e.g., ranges of “less than or equal to about 25 wt %, or, more specifically, about 5 wt % to about 20 wt %,” is inclusive of the endpoints and all intermediate values of the ranges of “about 5 wt % to about 25 wt %,” etc.).

Unless defined otherwise, technical and scientific terms used herein have the same meaning as is commonly understood by one of skill in the art to which this invention belongs. Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

As used herein, the term “hydrocarbyl” refers broadly to a substituent comprising carbon and hydrogen, optionally with 1 to 3 heteroatoms, for example, oxygen, nitrogen, halogen, silicon, or sulfur; “alkyl” means a straight or branched chain monovalent hydrocarbon group; “alkylene” means a straight or branched chain divalent hydrocarbon group; “alkylidene” means a straight or branched chain divalent hydrocarbon group, with both valences on a single common carbon atom; “alkenyl” means a straight or branched chain monovalent hydrocarbon group having at least two carbons joined by a carbon-carbon double bond; “cycloalkyl” means a non-aromatic monovalent inonocyclic or multicyclic hydrocarbon group having at least three carbon atoms, “cycloalkenyl” means a non-aromatic cyclic divalent hydrocarbon group having at least three carbon atoms, with at least one degree of unsaturation; “aryl” means an aromatic monovalent group containing only carbon in the aromatic ring or rings; “arylene” means an aromatic divalent group containing only carbon in the aromatic ring or rings; “alkylaryl.” means an aryl group that has been substituted with an alkyl group as defined above, with 4-methylphenyl being an exemplary alkylaryl group; “arylalkyl” means an alkyl group that has been substituted with an aryl group as defined above, with benzyl being an exemplary arylalkyl group; “alkoxy” means an alkyl group as defined above with the indicated number of carbon atoms attached through an oxygen bridge (—O—); and “aryloxy” means an aryl group as defined above with the indicated number of carbon atoms attached through an oxygen bridge (—O—).

Unless otherwise indicated, the groups herein can be substituted or unsubstituted. “Substituted” means a groups substituted with at least one (e.g., 1, 2, or 3) substituents independently selected from a halide (e.g., F⁻, Cl⁻, Br⁻, I⁻), a C₁₋₆ alkoxy, a nitro, a cyano, a carbonyl, a C₁₋₆ alkoxycarbonyl, a C₁₋₆ alkyl, a C₂₋₆ alkynyl, a C₆₋₁₂ aryl, a C₇₋₁₃ arylalkyl, a C₁₋₆ heteroalkyl, a C₃₋₆ heteroaryl (i.e., a group that comprises at least one aromatic ring and the indicated number of carbon atoms, wherein at least one ring member is S, N, O, P, or a combination thereof), a C₃₋₆ heteroaryl(C₃₋₆)alkyl, a C₃₋₈ cycloalkyl, a C₅₋₈ cycloalkenyl, a C₅ to C₆ heterocycloalkyl (i.e., a group that comprises at least one aliphatic ring and the indicated number of carbon atoms, wherein at least one ring member is S, N, O, P, or a combination thereof), or a combination including at least one of the foregoing, instead of hydrogen, provided that the substituted atom's normal valence is not exceeded.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A polycarbonate composition for an electrophotographic photoreceptor coating, wherein the polycarbonate comprises
1 to 100 mole percent of first units of the formula 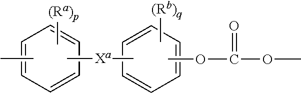
wherein
R^{a} and R^{b} are each independently halogen or C₁₋₆ alkyl, p and q are each independently 0 to 4, wherein at least one of p and q is 1 to 4, and
X^{a} is a C₅₋₁₈ cycloalkylidene or a C₇₋₂₅ alkylidene of formula —C(R^{c})(R^{d})—wherein R^{c} and R^{d} are each independently hydrogen, C₁₋₁₂ alkyl, C₃₋₁₂ cycloalkyl, C₇₋₁₂ arylalkyl, C₁₋₁₂ heteroalkyl, or cyclic C₇₋₁₂ heteroarylalkyl, provided that at least one of R^{c} and R^{d} is a C₆₋₁₆ cycloalkyl; and
0 to 99 mole percent of one or more second units different from the first units, of the formula 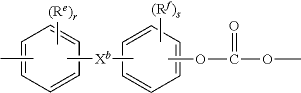
wherein
R^{e} and R^{f} are each independently a halogen or a C₁₋₁₂ alkyl group, r and s are each independently 0 to 4, and
X^{b} is a single bond, —O—, —S—, —S(O)—, —S(O)₂—, —C(O)—, or a C₄₋₂₅ alkylidene of formula —C(R^{g})(R^{h})—wherein R^{g} and R^{h} are each independently hydrogen, C₁₋₁₂ alkyl, C₇₋₁₂ arylalkyl, C₁₋₁₂ heteroalkyl, or cyclic C₇₋₁₂ heteroarylalkyl, or a group of the formula —C(═R¹)— wherein Rⁱ is a divalent C₁₋₁₂ hydrocarbon group; and
wherein the polycarbonate has a weight average molecular weight of at least 50,000 g/mole and a polydispersity index of 1 to 5.

2. The polycarbonate composition of claim 1, wherein the first units are of the formula

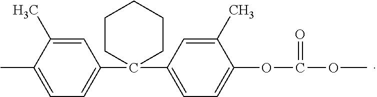

3. The polycarbonate composition of claim 2, wherein the polycarbonate comprises less than 2 weight percent of species having a molecular weight of less than 1,000 g/mol as determined by gel permeation chromatography.

4. The polycarbonate composition of claim 2, comprising
less than 2 parts per million by weight of a chloride ion, based on parts by weight of the polycarbonate composition, and
less than 1 part per million by weight of a nitrogen-containing compound, based on parts by weight of the polycarbonate composition.

5. The polycarbonate composition of claim 2, wherein a film formed from the polycarbonate composition has a scratch resistance of at least HB, measured according to the ASTM D3363-92 Pencil Hardness Test.

6. The polycarbonate composition of claim 2, wherein the weight average molecular weight of the polycarbonate is 50,000 to 150,000 g/mole.

7. The polycarbonate composition of claim 6, wherein the weight average molecular weight of the polycarbonate is 60,000 to 100,000 g/mole.

8. The polycarbonate composition of claim 6, wherein the weight average molecular weight of the polycarbonate is 70,000 to 85,000 g/mole.

9. The polycarbonate composition of claim 2, wherein the polycarbonate has a polydispersity index of 1.5 to 4.2.

10. The polycarbonate composition of claim 2, wherein the polycarbonate has a polydispersity index of 1.5 to 3.5.

11. The polycarbonate composition of claim 2, wherein the polycarbonate comprises less than 1 weight percent of species having a molecular weight of less than 1000 g/mol.

12. The polycarbonate composition of claim 2, wherein the polycarbonate comprises 20 to 100 mole percent of the first units.

13. The polycarbonate composition of claim 2, wherein the second monomer is derived from bisphenol A.

14. A polycarbonate composition for an electrophotographic photoreceptor coating, wherein the polycarbonate comprises
40 to 100 mole percent of first units of the formula 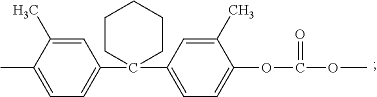
and
0 to 60 mole percent of carbonate units derived from bisphenol A, wherein the polycarbonate composition has
a weight average molecular weight of 60,000 to 100,000 g/mole,
a polydispersity index of 1.5 to 4.2,
less than 2 weight percent of species having a molecular weight of less than 1000 g/mol,
less than 2 parts per million by weight of chloride ion, based on parts by weight of the polycarbonate composition,
less than 1 part per million by weight of a nitrogen-containing compound, based on parts by weight of the polycarbonate composition, and
a film formed from the polycarbonate composition has a scratch resistance of H or harder, measured according to the ASTM D3363-92.

15. A coating composition for coating an electrophotographic photoreceptor, the coating composition comprising:
the polycarbonate composition of claim 2 or claim 14, and
an aprotic, volatile organic solvent effective to dissolve the polycarbonate composition,
wherein the concentration of the dissolved polycarbonate composition remains constant for a period of 4 weeks or more.

16. The coating composition of claim 15, wherein the aprotic, volatile organic solvent is selected from dichloromethane and tetrahydrofuran.

17. The coating composition of claim 15, wherein the polycarbonate is present in the solution in an amount of 5 to 50 weight/volume percent.

18. An electrophotographic photoreceptor comprising a charge transfer layer, the charge transfer layer comprising a charge transfer material and the polycarbonate composition of claim 2 or claim 14.

19. A method for producing an electrophotographic photoreceptor, the method comprising:
contacting a surface of a charge generation layer with a charge transfer solution comprising the coating composition of claim 15 and a charge transfer material; and
removing the solvent.

20. A method for producing an electrophotographic photoreceptor, the method comprising:
contacting an electrically conductive substrate of the electrophotographic receptor with a composition comprising a charge transfer solution comprising the coating composition of claim 15, a charge transfer material, and a charge generating material; and
removing the solvent.

21. A method of reducing the polydispersity index of a polycarbonate composition for an electrophotographic photoreceptor coating, the method comprising
contacting a solution comprising the polycarbonate of claim 2 and an organic solvent with an anti-solvent effective to precipitate the polycarbonate; and
separating the precipitated polycarbonate, to provide a separated polycarbonate composition having a weight average molecular weight of at least 50,000 g/mole, and polydispersity index of 1.5 to 4.2.

22. The method of claim 21, wherein the isolated polycarbonate comprises less than 2 weight percent of species having a molecular weight of less than 1,000 g/mol as determined by gel permeation chromatography

23. The method of claim 21, wherein the isolated polycarbonate comprises
less than 2 parts per million by weight of a chloride ion, based on parts by weight of the polycarbonate composition, and
less than 1 part per million by weight of a nitrogen-containing compound, based on parts by weight of the polycarbonate composition.

24. A method of reducing the polydispersity index of a polycarbonate composition for an electrophotographic photoreceptor coating, the method comprising
contacting a solution comprising
an organic solvent selected from dichloromethane, tetrahydrofuran, or a combination comprising at least one of the foregoing, and
a polycarbonate comprising 40 to 100 mole percent of first units of the formula 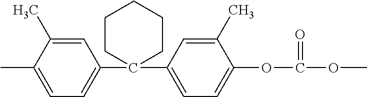
and 0 to 60 mole percent of carbonate units derived from bisphenol A, with an anti-solvent selected from a linear or aliphatic ketone, a cyclic ketone, acetic acid/acetonitrile mixture, or a combination comprising at least one of the foregoing, to precipitate the polycarbonate; and
separating the precipitated polycarbonate, to provide a separated polycarbonate composition having
a weight average molecular weight of 60,000 to 100,000 g/mole,
a polydispersity index of 1.5 to 4.2,
less than 2 weight percent of species having a molecular weight of less than 1000 g/mol,
less than 2 parts per million by weight of chloride ion, based on parts by weight of the polycarbonate composition,
less than 1 part per million by weight of a nitrogen-containing compound, based on parts by weight of the polycarbonate composition, and
a film formed from the polycarbonate composition has a scratch resistance of H or harder, measured according to the ASTM D3363-92.

25. The method of claim 19, wherein
the solvent is dichloromethane and the anti-solvent is acetone; and
the isolated polycarbonate has
a weight average molecular weight of 60,000 to 85,000 g/mole,
a polydispersity index of 1.5 to 3.5, and
less than 1 weight percent of species having a molecular weight of less than 1000 g/mol.

26. The method of claim 25, wherein the isolated polycarbonate has a weight a polydispersity index of 1.5 to less than 2.0.
